(19) United States
(12) Patent Application Publication
(10) Pub. No.: US 2013/0047790 A1
(43) Pub. Date: Feb. 28, 2013

(54) VARIABLE-SPAN MULTI-BLADE SCREWDRIVER

(71) Applicants: Faisal SHAH, Ashburn, VA (US); Saadullah MOHAMMAD, Leesburg, VA (US)

(72) Inventors: Faisal SHAH, Ashburn, VA (US); Saadullah MOHAMMAD, Leesburg, VA (US)

(73) Assignee: Verizon Patent and Licensing Inc., Basking Ridge, NJ (US)

(21) Appl. No.: 13/219,782

(22) Filed: Aug. 29, 2011

(51) Int. Cl. B25B 17/00

(52) U.S. Cl. 81/57.22

(57) ABSTRACT

Screwdriver apparatus for screwing-in, or unscrewing, two or more screws simultaneously. Gear linkage is provided to cause appropriate rotation of a plurality of appropriately-supported parallel shafts to simultaneously rotate and operate upon screws, such as two screws holding a line card in a router or switch within a telecommunications system. The distance between the parallel shafts is adjustable and under control of the user of the screwdriver. Any kind of screwdriver blade, such as Phillips, flat, etc., can be attached at the ends of the parallel shafts, and the blades need not match each other for any given usage. Rotational power for the screwdriver can be supplied by a human user or by a machine. Use of this tool facilitates adding or removing the aforementioned line cards, and saves technician time. Application of this tool is not limited to line cards.

### BACKGROUND

In the telecommunication area, there are routers, switches, and other hardware items which contain line cards or printed circuit boards and the like. From time to time, these line cards are physically addressed, or accessed, by a technician with a screwdriver for purposes of installing or removing the line cards, or for other troubleshooting purposes. There are multiple screws, inserted into and/or through those cards, which hold those cards in place within their respective router, switch, etc. These screws need to be screwed-in tightly to mount a card or unscrewed completely to remove the card.

In certain routers and switches there are two captive installation screws, displaced from each other, which are the above-noted screws that need to be tightened if being inserted into the card to hold it fixedly in place or need to be loosened if the card is targeted for removal. In many cases, the technician has to move his screwdriver back and forth many times between these two screws which are situated on a single card at two different locations, making only a few turns at each screw, to allow an even, or aligned, insertion or removal of the card and thereby avoid stripping the threads on the screws and/or on the screw receptacles. But, this can be a tedious process, particularly if the card and/or a mother-board to which the card may be connected, is crowded with components and/or wiring. That crowded environment calls for extra care when maneuvering a screwdriver back and forth within the wiring and components to achieve a mounting or a removal of that card.

Thus, there is a need for a device which can be inserted into multiple screws simultaneously and used to unscrew or screw-in the multiple screws simultaneously. That would eliminate need for movement of a screwdriver back and forth from one screw to the other, and thereby reduce technician time while also reducing likelihood of stripping the screws. Applicants disclose such a screwdriver apparatus herein.

### BRIEF DESCRIPTION OF THE DRAWINGS

FIG. 1 is an exemplary schematic diagram of an embodiment of the screwdriver present invention;

FIG. 2 is an exemplary schematic diagram of a portion of the outer structure of a rotatable shaft perpendicular to the shaft supporting the handle of the screwdriver in the embodiment of FIG. 1;

FIG. 3 is an exemplary schematic diagram of the inner structure of the rotatable shaft of FIG. 2;

FIG. 4 is an exemplary schematic diagram of a top view of a portion of the rigid T sleeve support shown in FIG. 1;

FIG. 5 is an exemplary schematic diagram of an alternative embodiment telescoping equivalent of the structure depicted in FIGS. 2 and 3;

FIG. 6 is an vertical cross sectional view of a portion of the telescoping structure of FIG. 5; and

FIG. 7 is an exemplary end view of a portion of the telescoping structure of FIG. 6.

### DETAILED DESCRIPTION OF PREFERRED EMBODIMENTS

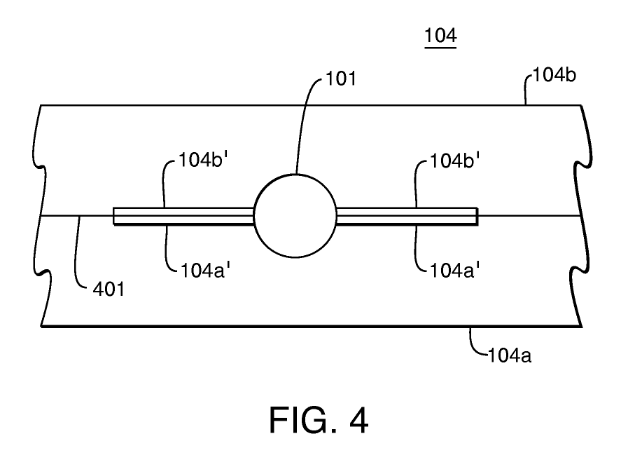

In this description, the same reference numeral in different Figs. refers to the same entity. Otherwise, reference numerals of each Fig. start with the same number as the number of that Fig. For example, FIG. 3 has numerals in the “300” category and FIG. 4 has numerals in the “400” category, etc.

In overview, preferred embodiments include apparatus and methodology for screwing-in or un-screwing multiple screws simultaneously. There is provided a plurality of rotatable shafts operatively interconnected by gear-linkage. A handle, supported by and enveloping one of the rotatable shafts, is provided and that handle is configured to be grasped by the hand of a user. There are screwdriver blades affixed to the ends of other rotatable shafts, the other shafts being substantially parallel to the one shaft, the handle-shaft. The other shafts are substantially equal in length to each other and displaced from each other by a distance established by the user. The screwdriver blades each engage and simultaneously rotate a different screw when the handle shaft is rotated by the user. The simultaneous rotation of the different screws can all be in the same rotational direction, or one or more of the plurality of screws can rotate in an opposite direction to the rotational direction of one of the screws.

In a particular embodiment there are two parallel shafts with screwdriver blades and three gear boxes. A first of the gear boxes links the handle shaft with two other rotatable shafts that are substantially perpendicular to the handle shaft. A second gear box links one of the perpendicular shafts to one of the parallel shafts. A third gear box links the other of the perpendicular shafts to the other of the parallel shafts.

This apparatus and methodology operate with two screws separated from each other and screwed-into to a planar structure, such as, e.g., a line card associated with, e.g., a router or switch included in a telecommunications network. The particular embodiment can be hand operated by a technician/user or can be power-driven. The particular distance between the two parallel shafts can be adjusted by the user to accommodate different separation distances between different pairs of screws. Certain standard line cards with standard distances between screws can be readily accommodated with selectable standard positions in the apparatus causing its screw blades to be aligned with the line card screws. Different style screw blades can be used to accommodate any wood screw or machine screw, such as those having, e.g., a Phillips head style or a flat-head style. One blade can be in accordance with one style while the other blade can be in accordance with any different style and this is achieved by plugging-in each blade into its receptive slot formed in the end of one of the parallel shafts. A single shaft screwdriver employing a receptive slot at the end of its shaft to receive one of a number of different-styled blades is commercially available.

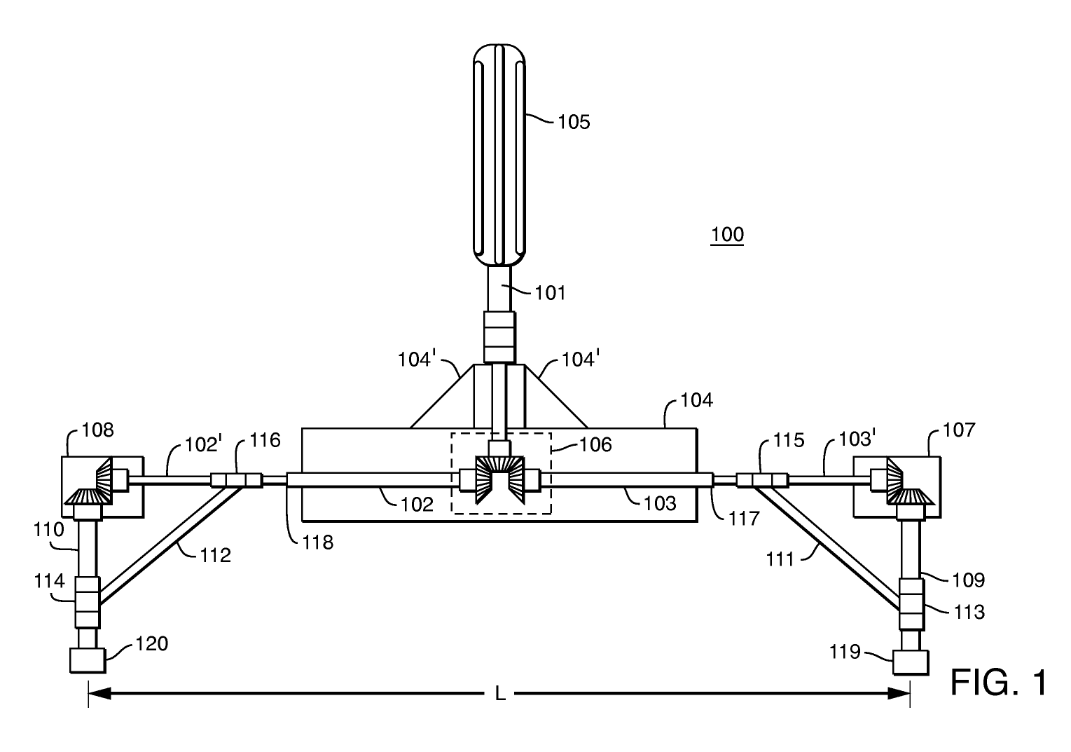

FIG. 1 is an exemplary schematic diagram of a first embodiment 100 of the screwdriver of the present invention. A rotatable shaft 101 supports handle 105 which envelopes the shaft. The handle is suitable for hand grasping, and rotatable force can be applied to the handle by a user, or the handle can be detached and the shaft can be motor-driven. (motor not shown) Rotatable shafts 102 and 103 are directed perpendicular to shaft 101 and are sometimes referred to hereinafter as “perpendicular shafts.” The perpendicular shafts are operatively linked to shaft 101 by way of bevel gears included in gear box 106. The bevel gears and their gear box are standard. The axes of rotation of shafts 101, 102 and 103 are substantially co-planar.

Shafts 101, 102 and 103 as well as gear box 106 are all contained within rigid-inverted-T-shaped-sleeve 104, referred to hereafter as a T sleeve. The T sleeve can be made from metal or stiff plastic and configured with precise tolerance to permit rotational motion of all three shafts while, at the same time, offering rigidity and support to the screwdriver apparatus. If made from clear plastic, the T-sleeve can be transparent where the internally supported shafts 102 and 103 would be visible, as shown, and gear box 106 would have been shown as a solid line instead of a dashed line. If made from opaque plastic or metal, then gear box 106 would not be visible in this view as shown by hidden line 106 and shafts 102 and 103 would also not be visible and would have been shown as dashed hidden lines instead of the solid lines presented. In either case, the gears within gearbox 106 are not visible and are depicted herein only to enhance clarity of presentation. Bracing structure 104′ offers additional rigidity for T sleeve 104. The three shafts can be appropriately lubricated to facilitate rotation within the T sleeve.

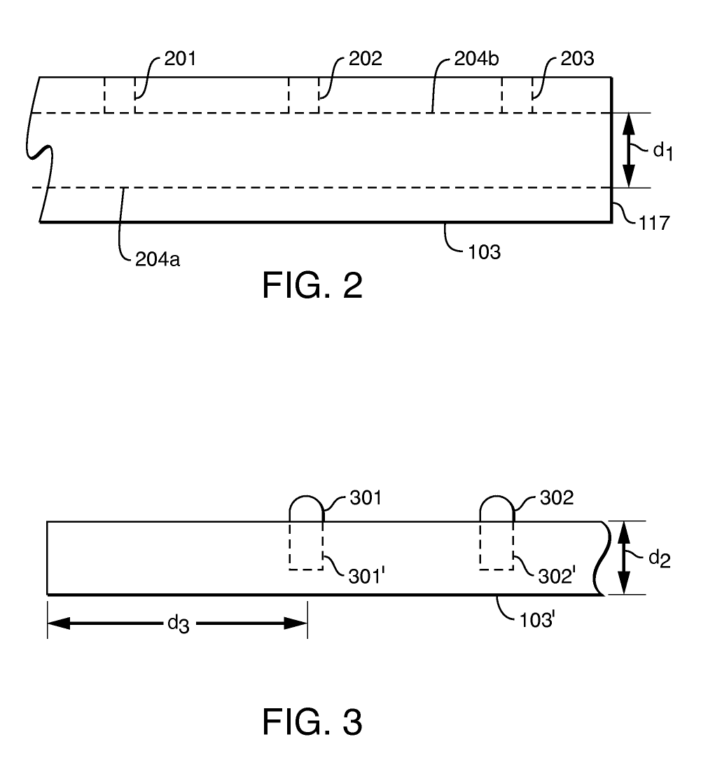

Rotatable perpendicular shafts 102 and 103 are extended axially by way of extender shafts 102′ and 103′ respectively. The extension is made to accommodate length L, the distance between two screws to be inserted or removed. Shafts 102 and 103 can be configured to provide standard lengths only, or can also be configured to provide other adjustable or selectable lengths, to be described in connection with FIGS. 2, 3 and 5. Extender shafts 102′ and 103′ extend co-axially from ends 118 and 117 of perpendicular shafts 102 and 103, respectively, and are operatively coupled to standard bevel gears in standard gear boxes 108 and 107, respectively. The manner of connecting the extender shafts from perpendicular shafts 102 and 103 is detailed below.

Gear box 107 is operatively coupled to rotatable shaft 109 and gear box 108 is operatively coupled to rotatable shaft 110. Shafts 109 and 110 are parallel to each other and to rotatable shaft 101. Shafts 109 and 110 are sometimes referred to hereinafter as “parallel shafts.” The axes of rotation of shafts 101, 109 and 110 are substantially coplanar. Shafts 109 and 110 are of equal length to each other and have mechanisms 119 and 120, respectively, at the ends of their shafts, each for receiving and holding a screw-blade (not shown). Mechanisms 119 and 120 can be permanently magnetized, so that the screws being inserted or removed (assuming iron or steel screws) can be more easily manipulated. If a blade which is aligned with its respective screw is not perfectly aligned with the groove of its respective screw initially, merely rotating the blade shall align the blade with the groove.

Viewing handle 105 from its end (top of FIG. 1), it is clear that if a clockwise rotation is applied to the handle, then the gear arrangement causes a clockwise rotation of parallel shaft 110 and a clockwise rotation of parallel shaft 109, without need for an additional gear-reversal mechanism. Similarly, a counterclockwise rotation applied to the handle produces counterclockwise rotations of both shafts 109 and 110. However, one of the two gear boxes 107 or 108 could include additional direction-reversing gears (not shown), if there happened to be a need for other than both parallel shafts rotating in the same direction responsive to handle rotation.

Truss connector or cross brace I 1 I connects (through hollow sleeves 113 and 115) parallel shaft 109 directly to perpendicular shaft 103′ and cross brace 112 connects (through hollow sleeves 114 and 116) parallel shaft 110 directly to perpendicular shaft 102′. Each hollow sleeve is cylindrically-shaped with an inner diameter having precise tolerance to permit rotational motion of its respective shaft while, at the same time, its connection via the truss support between rotating shafts prevents unwanted motion of the shafts. In other words, the two truss connectors eliminate unwanted motion of their respective parallel shafts relative to their respective perpendicular shafts while permitting rotational motion.

In addition to the truss supports, or instead of the truss supports, a plastic or metal “snap-together-elbow” support (not shown) could be used over gear box 108 and over rotatable shafts 110 and 102′. Another plastic or metal “snap-together-elbow” support (not shown) could be used over gear box 102 and over rotatable shafts 109 and 103′. These elbows would provide a rigidity function with respect to gear boxes 107 and 108 and their respective rotatable shafts, similar to that function provided by T-support 104 with respect to gear box 106 and its rotatable shafts.

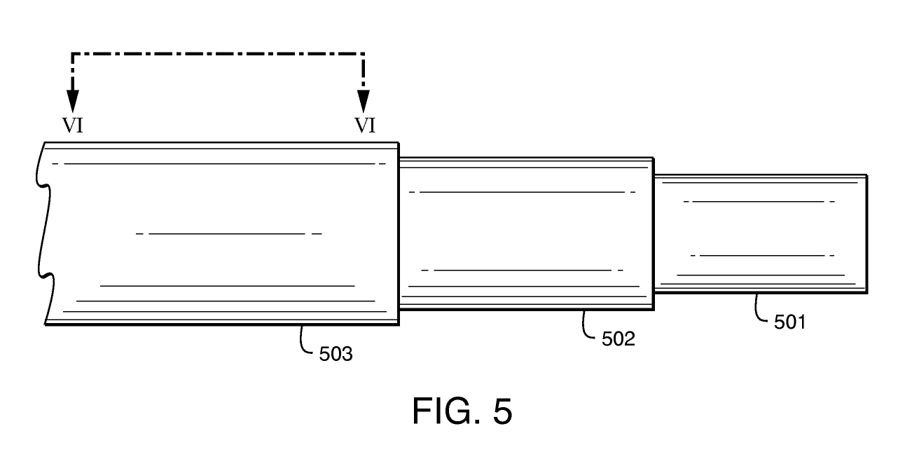

FIG. 2 is an exemplary schematic diagram of a portion of the outer structure of rotatable perpendicular shaft 103 depicted in FIG. 1 in accordance with the first embodiment. Perpendicular shaft 103 may be cylindrically shaped in its exterior and may contain a cylindrical cavity represented in FIG. 2 by hidden dashed lines 204a and 204b. In addition, shaft 103 may contain multiple apertures, such as apertures 201, 202 and 203, also depicted by hidden dashed lines. These apertures, as well as similar companion apertures contained in shaft 102, are not shown in FIG. 1, but they are holes which run from the inner cylindrical surface to the outer cylindrical surface of hollow cylinder 103 and a similar hollow cylinder for shaft 102 (not shown), and serve as detent positions for securing an extender shaft, described below. There may be more or fewer apertures than the three depicted, and they may be evenly or un-evenly spaced apart. The apertures may also be cylindrically shaped. These detent positions in combination with other detent positions in shaft 102 can be configured to provide lengths L that are standard lengths for standard line cards or standard lengths for other components secured by screws. The shafts could also contain other holes at other locations that would offer a variety of distances L, other than standard distances. This variety can be further augmented by a telescoping feature to be discussed in connection with FIG. 5. to be able to accommodate virtually any length L desired, within a maximum L limit.

FIG. 3 is an exemplary schematic diagram of extender shaft 103′ which is the inner structure of rotatable perpendicular shaft 103 of FIG. 2. Extender shaft 103′ is a solid cylinder which supports spring-loaded buttons 301 and 302. The buttons can be depressed into their respective cavities 301′ and 302′ by a screwdriver user, as extender shaft 103′ is inserted into perpendicular shaft 103. The left-hand side of extender shaft 103′ fits inside the right-hand side of perpendicular shaft 103. Outside diameter d₂ of extender shaft 103′ is slightly smaller than inside diameter d₁ of perpendicular shaft 103, so that extender shaft 103′ can be fitted into shaft 103. The axes of both shafts would then be substantially co-axial. Also, the insertion technique can involve a rotational offset of shaft 103′ relative to shaft 103, to permit buttons 301 and 302 to bypass certain of the holes during insertion until the appropriate hole is matched with the appropriate button whereupon a twisting action can result in the appropriate button snapping into the appropriate hole.

Extender shaft 103′ can be inserted into shaft 103 by a minimum overlap distance d₃ represented by button 301 snapping into aperture 203. This would lock both shafts together and the locked shafts would provide a fixed distance in their co-axial direction. Furthermore, both shafts would then be constrained to rotate together. Minimum distance d₃ can be selected to be whatever minimum distance is needed to provide sufficient rigidity to both shafts, and a reasonable minimal overlap between the two shafts may be a 50% overlap, where extender shaft 103′ penetrates into shaft 103 by 50% of the length of shaft 103 and by 50% of the length of shaft 103′. This would occur when the lengths of shafts 103 and 103′ are equal. Extender shaft 103′ can penetrate into shaft 103 by more than that amount by having button 301 snap into aperture 202, or even into aperture 201.

Button 302 is provided and is displaced from button 301 by a distance that is other than the distance between holes 201 and 202 or between holes 202 and 203. Therefore, if button 302 is inserted into one of holes 201, 202 or 203 instead of button 301, that connection offers additional variety to the distance between screw blades if desired, which would be the case if length L of FIG. 1 is not standard in a particular application. Further, there can be a large number of buttons, more than the two shown, set apart from each other at progressively smaller distances which, in combination with apertures 201, 202 and 203 would allow for an even larger variety of selectable distances for length L. There can also be more apertures that the three shown and they can be set apart from each other at progressively smaller distances, also offering a variety of selectable distances for length L.

The description of shaft connection and operation provided in the preceding paragraphs with respect to perpendicular shaft 103 and extender shaft 103′ are directly applicable to connection and operation with respect to perpendicular shaft 102 and extender shaft 102′, in a mirror-image context. Therefore, that detail won't be repeated for perpendicular shaft 102. However, it should be appreciated that locations of various holes and spring-loaded buttons used in perpendicular shaft 102 and extender shaft 102′ need not be equal to, nor mirror-image symmetrical with respect to, locations in perpendicular shaft 103 and extender shaft 103′. In fact, inequality and asymmetry in this respect is advantageous, because that would provide a wider variety of possible lengths L (L shown in FIG. 1), including default standard lengths, as a result.

Returning to FIG. 1, extender shafts 102′ and 103′ are shown connected to gears in gear boxes 108 and 107, respectively. As an alternative embodiment, extender shafts 102′ and 103′ could be configured to interconnect with additional shafts (not shown) similar to 102 and 103 which, in turn, would be the shafts that connect directly to the gears. In other words, the right hand side of FIG. 1 would reflect perpendicular arm 103 snap-connected to extender arm 103′ which, in turn, would be snap-connected to another co-axial perpendicular arm (not shown, but having the same inner diameter d₁ as that of arm 103) that would, in turn, connect directly to a gear in gear box 107. And, the left hand side of FIG. 1 would reflect perpendicular arm 102 snap-connected to extender arm 102′ which, in turn, would be snap-connected to another co-axial perpendicular arm (not shown, but having the same inner diameter d₁ as that of arm 102) that would, in turn, connect directly to a gear in gear box 108. There could be a large number of these additional shafts of varying lengths, thereby providing a wide variety of lengths L.

FIG. 4 is an exemplary schematic diagram of a top view of a portion of the rigid T sleeve support 104 shown in FIG. 1. Shaft 101 is shown with handle 105 removed. T support 104 has mirror image halves 104a and 104b, including truss structure 104a′ and 104b′, which congruently fit together along seam 401. The mirror image halves and truss structure (104a, 104a′ and 104b, 104b′) can snap and lock together, and can be readily taken apart as may be needed. Bracing structure 104a′ and 104b′ is shown in this top view as solid structure that can operate as a truss to offer additional rigidity to T sleeve 104. The T sleeve including its truss structure can be made from metal or hard plastic. And the various rotatable shafts, gears, gear boxes, truss supports and any other necessary structure can all be made from metal or hard plastic.

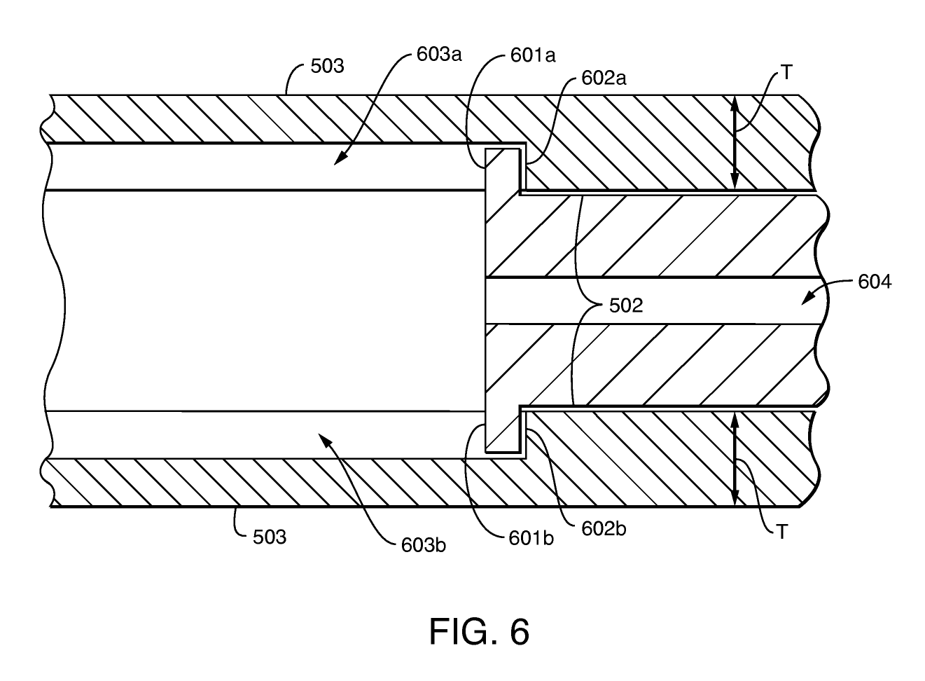

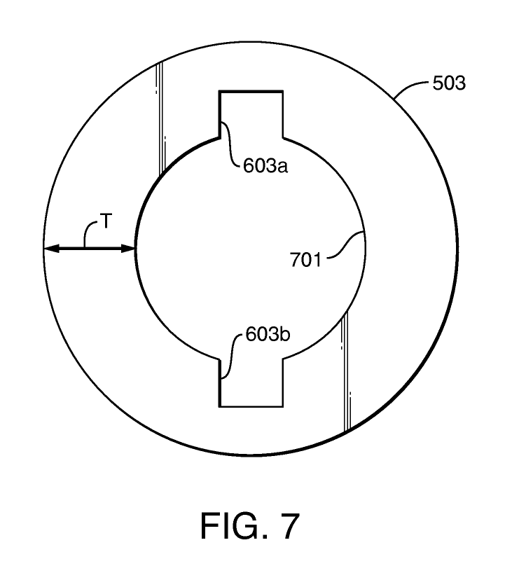

FIG. 5 is an exemplary schematic diagram of a second embodiment, namely a telescoping equivalent of the structure depicted in FIGS. 2 and 3. Instead of the snap-together extenders, a telescoping extender can be used, as shown in FIG. 5. Component 501 slides (telescopes) into component 502 which, in turn, slides into component 503. This operates similarly to how a radio antenna might be manually adjusted, to telescope into a greater or smaller effective length. As before, sufficient minimum overlap, per component, would have to be maintained to ensure sufficient overall rigidity. This can be accomplished by having “stops” (not shown in this Fig. but shown in FIGS. 6 and 7) built into the telescoping components at predetermined locations to ensure a particular overlap, e.g., 50% overlap, if that were the overlap desired. This telescoping embodiment could also use spring loaded snap buttons with their complementary apertures to add axial-length certainty and rotational rigidity, as discussed above. Or, this embodiment can be held in an axially-directed fixed position by a tight fit between telescoping components, while the rotational integrity can be achieved by the above noted spring loaded snap buttons or by a tongue and groove technique described below.

FIG. 6 is a vertical cross sectional view of a portion of the telescoping structure of FIG. 5, and more specifically of the telescoping component 503 portion. Cylindrical telescoping component 502 slides within component 503. The components may be cylindrical or have a different cross section, such as, e.g., square or rectangular. A square or rectangular cross-section could avoid the need of an interlocking tongue and groove design which is built into this second embodiment, as follows.

Tabs or protrusions 601a and 601b, at opposite sides of component 502 and on one end of component 502, extend radially from the outer surface of component 502 and slide within grooves or channels 603a and 603b formed in the wall of cylindrical-component 503. The thickness of that wall is shown as “T” and the groove or channel has a depth of approximately T/2. Tabs 601a and 601b make physical contact with limit stops 602a and 602b, respectively, when component 502 penetrates component 503 to its maximum allowed extent. Stops 602a and 602b prevent cylindrical component 502 from penetrating any further into cylindrical component 503, beyond stops 602a and 602b. This limit on penetration ensures sufficient component overlap and, therefore, sufficient rigidity of the perpendicular shaft.

Component 502 also has grooves or channels formed in its wall, configured to accept different tabs (not shown) located on cylindrical component 501 (not shown in FIG. 6). Channel 604 is one of those channels formed in the wall thickness of component 502 and is shown as being angularly displaced from channels 603a and 603b by approximately 90 degrees. There is another channel (not shown) formed in the wall thickness of component 502, directly opposite from channel 604, similar to the arrangement of channels 603a and 603b in component 503, but offset from them by approximately 90 degrees. A tab located on component 501 (not shown) would slide within channel 604, and a similar tab directly opposite that tab on component 501 would slide within the other channel directly opposite from channel 604. These interlocks (tabs and grooves) would then constrain the combined shaft comprised of components 501, 502 and 503 to rotate together, and the limit-stops (602a, 602b, etc.) limit its overall length.

Further, if the fit between the three telescoping components was sufficiently tight, then the need for button connections to fix length in the axial direction could be eliminated. After length L is set manually, the forces on rotatable perpendicular combined shaft 501/502/503 are torsional or rotational rather than axial, wherefore the button constraints to fix length could be avoided. Cylindrical components 503 and 502, as well as cylindrical component 501 (not shown in this Fig.) together comprise a complete perpendicular shaft described above. The foregoing describes one of the two disclosed perpendicular shafts, and a similar configuration and arrangement of tabs and grooves can be used on the opposite perpendicular shaft so that they both function and operate in the same manner. Or, the opposite perpendicular shaft can be of fixed length, where all length L variation is obtained via only one of the two perpendicular shafts.

FIG. 7 is a schematic drawing of an end view of only component 503, looking at it from the left hand side of FIG. 6. Component 503 is cylindrical with wall thickness T. Channels or grooves 603a and 603b are formed in wall thickness T, directly opposite each other. Component 503 has inner wall 701 bounding a cylindrical space into which component 502 (not shown to enhance clarity of illustration) may be inserted. Component 502 may be inserted with only one of two orientations, where the tabs on component 502 must fit into grooves 603a and 603b. If the grooves 603a and 603b were not directly opposite each other, in a particular configuration, then there would be only one keying orientation possible for component 502.

If square or rectangular perpendicular shafts were used instead of cylindrical perpendicular shafts where, e.g., a square exterior for component 502 fit matingly into a square aperture within component 503, then the keying mechanisms (tab and groove) would not be needed. In other words, a square outer shaft configuration for shaft 502 fitting into a square inner shaft configuration for shaft 503 would be constrained to rotate together.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. For example, in the disclosed embodiments, only two screws are shown, but the claimed apparatus and methodology are not limited to operating with only two screws - three or more screws could be simultaneously operated upon in embodiments intended to be embraced by the appended claims.

For another alternative embodiment, in the above-described third gear box, there could be an additional mesh gear to reverse the rotational motion of its associated parallel shaft from the direction it would have otherwise assumed without operation of the additional mesh gear. In this manner, using the two screw embodiment as an example, one screw could be rotated clockwise while the other screw could simultaneously be rotated counterclockwise.

For yet another alternative embodiment, the structure of FIGS. 2 and 3, using spring-loaded buttons that snap into holes to hold the perpendicular shafts rigid, could be combined with the structure of FIGS. 5, 6 and 7, using a telescopic structure. In other words, telescopic segment 502 could snap together with telescopic segment 503 at, e.g., standard lengths L while telescopic segment 501 could operate as discussed with respect to FIGS. 5, 6, and 7, thereby offering a flexibility to “tune” the length L to mate with an un-conventional distance between two screws, as may be needed.

The present invention is thus not to be interpreted as being limited to particular extender shafts or particular numbers of gear boxes or particular numbers of perpendicular shafts. Therefore, the specification and drawings are to be regarded in an illustrative rather than restrictive sense.

What is claimed is:

1. A screwdriver for inserting or removing screws, said screwdriver comprising:
a plurality of rotatable shafts operatively interconnected by gear-linkage;
a handle, supported by and enveloping one of said rotatable shafts, said handle configured to be grasped by a hand of a user of said screwdriver; and
blades, affixed to ends of other of said rotatable shafts, said other shafts being substantially parallel to said one rotatable shaft and identified as parallel shafts, said parallel shafts being substantially equal in length to each other and displaced from each other by a distance established by said user.

2. The screwdriver of claim 1 wherein each of said blades is affixed to a different one of said parallel shafts and configured to engage with, and simultaneously rotate, a different one of said screws when said one rotatable shaft is rotated by said user, said blades rotating clockwise together or rotating counterclockwise together responsive to rotation of said handle.

3. The screwdriver of claim 2 wherein said parallel shafts are two shafts.

4. The screwdriver of claim 3 wherein said gear linkage comprises three gear boxes, a first of said boxes linking said one rotatable shaft with two other rotatable shafts substantially perpendicular to said one rotatable shaft and identified as perpendicular shafts.

5. The screwdriver of claim 4 wherein one of said two perpendicular shafts is linked through a second of said gear boxes to one of said parallel shafts and the other of said two perpendicular shafts is linked through a third of said gear boxes to the other of said parallel shafts.

6. The screwdriver of claim 1 wherein said gear linkage comprises three gear boxes, a first of said boxes linking said one rotatable shaft with two other rotatable shafts substantially perpendicular to said one rotatable shaft, one of said two perpendicular shafts linked through a second of said gear boxes to one of said parallel shafts and the other of said two perpendicular shafts linked through a third of said gear boxes to the other of said parallel shafts, and wherein said third of said gear boxes includes additional mesh gears to reverse rotational motion of its associated said parallel shaft from the direction said associated said parallel shaft would have otherwise assumed without operation of said additional mesh gears and thereby cause said one parallel shaft and said other parallel shaft to simultaneously rotate in opposite directions when said handle is rotated.

7. The screwdriver of claim 5 wherein said first gear box and portions of both said one rotatable shaft and both said perpendicular rotatable shafts are encapsulated by a rigid T sleeve configured to provide sufficient structural support for said screwdriver while simultaneously providing sufficient clearance to permit said one rotatable shaft and said perpendicular rotatable shafts to freely rotate responsive to rotational motion applied to said handle by said user.

8. The screwdriver of claim 7 wherein said T sleeve is configured in two substantially identical halves which are congruently connectable to each other, to form said T sleeve enveloping said first gear box, said one rotatable shaft and said perpendicular rotatable shafts.

9. The screwdriver of claim 8 wherein a first truss connector is configured to eliminated unwanted movement of said rotatable perpendicular shaft associated with said second gear box relative to said parallel shaft associated with said second gear box while simultaneously not inhibiting rotational motions of said rotatable perpendicular shaft associated with said second gear box and said parallel shaft associated with said second gear box.

10. The screwdriver of claim 9 wherein a second truss connector is configured to eliminate unwanted movement of said rotatable perpendicular shaft associated with said third gear box relative to said parallel shaft associated with said third gear box while simultaneously not inhibiting rotational motions of said rotatable perpendicular shaft associated with said third gear box and said parallel shaft associated with said third gear box.

11. The screwdriver of claim 10 further comprising at least one extender shaft, fixedly connected by said user to, and co-axially aligned by said user with, at least one of said parallel shafts, to increase said distance as desired by said user.

12. The screwdriver of claim 11 wherein said two substantially identical halves are manually dis-connectable by said user to remove said T sleeve to facilitate adding or removing said at least one extender shaft.

13. The screwdriver of claim 1 I wherein said extender shaft includes manually operable spring-loaded buttons for matingly engaging apertures formed in at least one of said perpendicular rotatable shafts, thereby forming an interlock to fix overall length of the resulting perpendicular-extender shaft combination while constraining rotational motion of said perpendicular shaft and said extender shaft to be identical.

14. The screwdriver of claim 11 wherein said at least one extender shaft telescopes axially from said at least one of said perpendicular shafts, said axially telescoping extender shaft being constrained in its axial displacement by a physical limit stop at one end of a tongue and groove channel formed in the axial direction, said channel engaging both said perpendicular shaft and said extender shaft to further constrain rotational motion of said extender shaft to be the same as that of said perpendicular shaft.

15. The screwdriver of claim 8 wherein a first elbow sleeve is configured to eliminate unwanted movement of said rotatable perpendicular shaft associated with said second gear box relative to said parallel shaft associated with said second gear box while simultaneously not inhibiting rotational motions of said rotatable perpendicular shaft associated with said second gear box and said parallel shaft associated with said second gear box.

16. The screwdriver of claim 9 wherein a second elbow sleeve is configured to eliminate unwanted movement of said rotatable perpendicular shaft associated with said third gear box relative to said parallel shaft associated with said third gear box while simultaneously not inhibiting rotational motions of said rotatable perpendicular shaft associated with said third gear box and said parallel shaft associated with said third gear box.
